(19) United States
(12) Patent Application Publication
(10) Pub. No.: US 2024/0394888 A1
(43) Pub. Date: Nov. 28, 2024

(54) IMAGE ANALYSIS METHOD AND IMAGE ANALYSIS APPARATUS

(71) Applicant: VIVOTEK INC., New Taipei City (TW)

(72) Inventor: Shu-Shu Chiu, New Taipei City (TW)

(73) Assignee: VIVOTEK INC., New Taipei City (TW)

(21) Appl. No.: 18/646,786

(22) Filed: Apr. 26, 2024

(30) Foreign Application Priority Data
May 23, 2023 (TW) 112119050

(51) Int. Cl. G06T 7/11; G06V 10/764; G06V 20/52

(52) U.S. Cl. CPC G06T 7/11; G06V 10/764; G06V 20/52

(57) ABSTRACT

An image analysis method is applied to an image analysis apparatus having an operation processor and an image receiver. The image analysis method includes setting a range provided by an original image as a reference image, and dividing the reference image into a plurality of first auxiliary images in accordance with a valid size. The plurality of first auxiliary images is applied for an image analysis model to generate an image classification result. The operation processor divides the base image acquired by the image receiver into a plurality of second auxiliary images in accordance with the valid size, and the plurality of second auxiliary images is applied for the image analysis model to decide a number of the plurality of first auxiliary images.

### BACKGROUND OF THE INVENTION

### 1. Field of the Invention

The present invention relates to an image analysis method and an image analysis apparatus, and more particularly, to an image analysis method of increasing image classification result and a related image analysis apparatus.

### 2. Description of the Prior Art

A surveillance camera may lose focus due to weather conditions, external forces, or use fatigue, which causes the captured image to be blurry. Even if the surveillance camera performs an automatic focusing function, it is difficult to ensure that the surveillance camera completed the automatic focusing function can continuously capture the clear captured image. The conventional surveillance camera analyzes spatial domain information of the captured image to determine a focus state; however, an amount of the spatial domain information of the captured image is huge, which requires a large-capacity memory unit to store related information of the captured image, and further requires complex computation process and lengthy computation time period to determine the focus state of the captured image. Even though the captured image is divided into several auxiliary images for analysis, a classification result of the image focus state is still determined by long-term computation. Therefore, design of an image analysis method and a related image analysis apparatus capable of increasing image classification accuracy of an image classification result via down-sampling technology is an important issue in the surveillance camera industry.

### SUMMARY OF THE INVENTION

The present invention provides an image analysis method of increasing image classification result and a related image analysis apparatus for solving above drawbacks.

According to the claimed invention, an image analysis method is applied to an image analysis apparatus, the image analysis apparatus has an operation processor and an image receiver, the image receiver is adapted to acquire an original image relevant to a surveillance environment. The image analysis method setting a range provided by the original image as a reference image, and dividing the reference image into a plurality of first auxiliary images in accordance with a valid size, so as to apply the plurality of first auxiliary images for an image analysis model to generate an image classification result. The operation processor is further adapted to divide a base image acquired by the image receiver into a plurality of second auxiliary images in accordance with the valid size, and apply the plurality of second auxiliary images for the image analysis model to decide a number of the plurality of first auxiliary images.

According to the claimed invention, an image analysis apparatus includes an image receiver and an operation processor. The image receiver is adapted to acquire an original image. The operation processor is electrically connected with the image receiver, and adapted to execute the foresaid image analysis method.

The image analysis apparatus and the image analysis method of the present invention can divide the original image into the plurality of auxiliary images in accordance with the crop size and/or the valid size via down-sampling technology, and apply the plurality of auxiliary images for the image analysis model to acquire the image classification result, so as to rapidly and accurately acquire the classification rules that best match with the input image matched of the image analysis model and the target label of the expected model; then, the original image can be reduced to generate the reference image, and the reference image can be divided into the plurality of auxiliary images in accordance with the crop size and/or the valid size to apply for the image analysis model, so as to decide the feature range and precise features of the input image. Comparing to prior art that an analysis model retrains the base model for adjustment of the classification result, the image analysis apparatus and the image analysis method of the present invention does not re-execute the training process of the base model, and can apply the matching parameters of the original base model directly for the reduced original image, so as to dynamically adjust the strict classification criterion to the loose and expected classification criterion, and further to increase the feature difference and enhance the image classification result, for achieving the expected effect of effectively adjusting the classification.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image analysis apparatus according to an embodiment of the present invention.

FIG. 2A and FIG. 2B are flow charts of an image analysis method according to the embodiment of the present invention.

FIG. 3 and FIG. 4 are diagrams of the original image acquired by the image analysis apparatus in different operation modes according to the embodiment of the present invention.

FIG. 5 to FIG. 7 are diagrams of utilizing the original image to generate the analysis image and reduction of the reference image according to different embodiments of the present invention.

FIG. 8 to FIG. 11 are diagrams of the original image in different transformation phases at the frequency domain according to the embodiment of the present invention.

FIG. 12 to FIG. 15 are diagrams of the base model and the auxiliary images of the input image according to different embodiments of the present invention.

FIG. 16 is a flow chart of the image analysis method according to the embodiment of the present invention.

### DETAILED DESCRIPTION

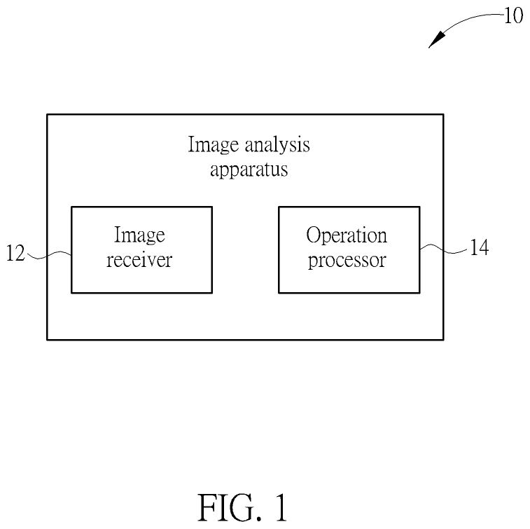

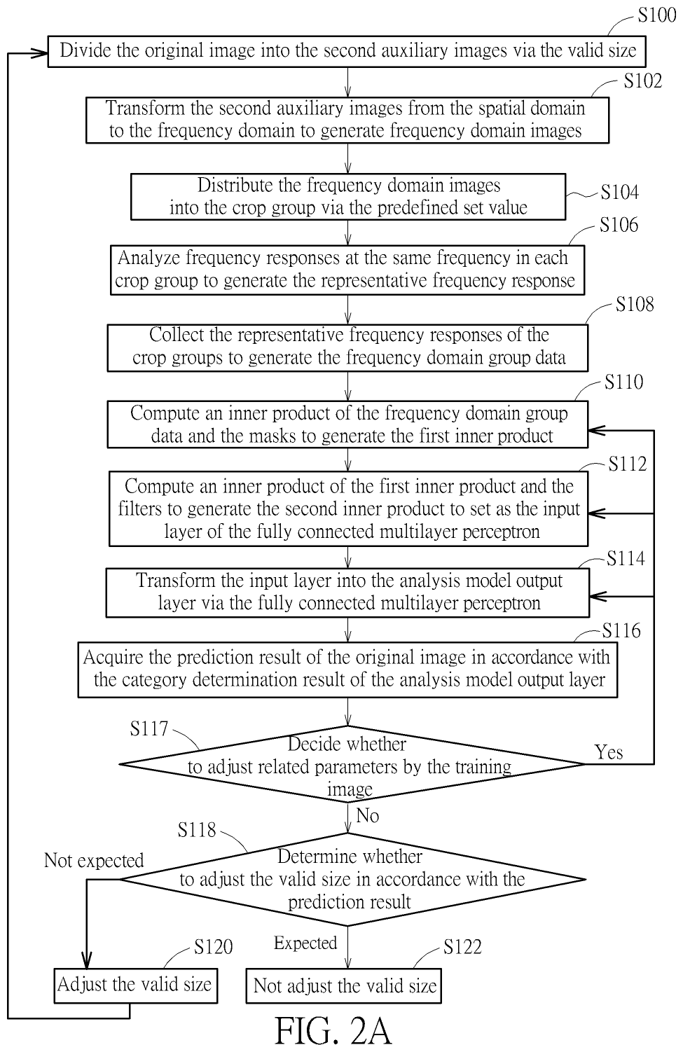

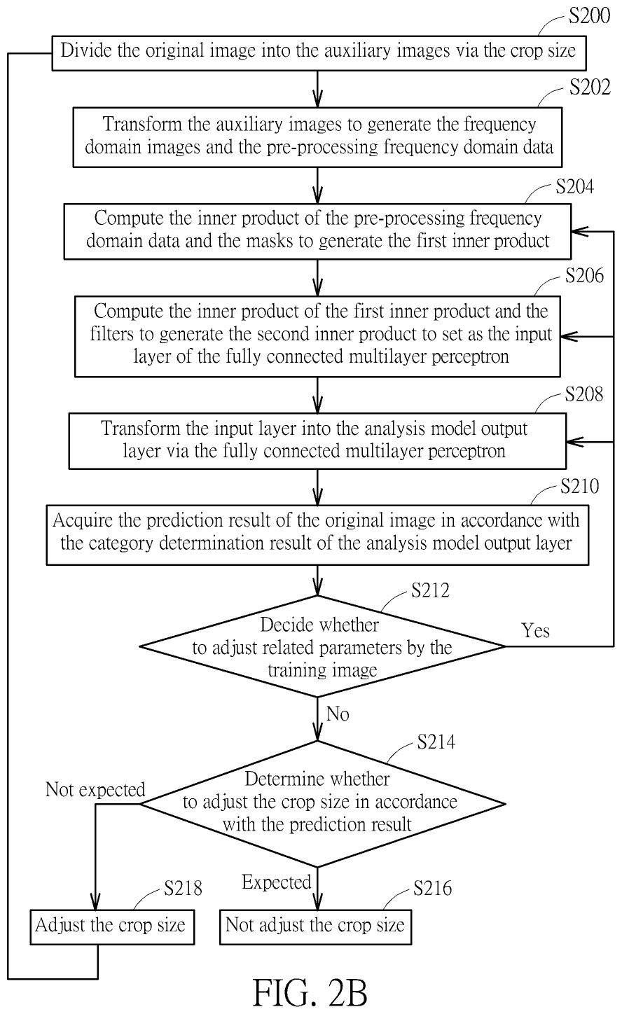

Please refer to FIG. 1, FIG. 2A and FIG. 2B. FIG. 1 is a functional block diagram of an image analysis apparatus 10 according to an embodiment of the present invention. FIG. 2A and FIG. 2B are flow charts of an image analysis method according to the embodiment of the present invention. The image analysis apparatus 10 can include an image receiver 12 and an operation processor 14. The image receiver 12 can capture an original image relevant to a surveillance environment, or receive the original image captured by an external camera and relevant to the surveillance environment. The operation processor 14 can be electrically connected to the image receiver 12 in a wired manner or in a wireless manner. In one embodiment, the image analysis apparatus 10 can be optionally disposed on the road, and a vehicle on the road can be an object to be identified; the original image can be an image of the road and the vehicle. The vehicle may only occupy a part of the original image, and the operation processor 14 can execute the image analysis method of the present invention used to decide how to adaptively adjust an image analysis model, and apply a specific range provided by the original image for the image analysis model, so as to increase feature difference and an image classification result.

For example, if the image analysis apparatus 10 is in a training process, the original image can be divided via a crop size and applied for the image analysis model to acquire optimal solution of the crop size; then, a valid size can be acquired in accordance with the crop size and used to divide the original image, and a division result of the original image can be applied for the image analysis model to acquire optimal solution of the valid size, so as to acquire the image classification result of the image analysis model and complete training of the base model. In the embodiment of the present invention, the training of the base model can include, but not be limited to, learning of an image classification feature or an image classification rule or any focus types to achieve the related image classification result. As if the image analysis apparatus 10 no longer or does not need to execute the training process, the image analysis apparatus 10 can decide whether to change a classification criterion. If the classification criterion is intended to change, a size of the original image can be varied, and parameter matching can be performed based on the optimal solution of the crop size and the valid size of the base model, so the classification criterion can be changed for optimization. If the classification criterion is not intend to change, the size of the original image can be kept without reduction and an interval between auxiliary images can be dynamically adjusted, so that the image analysis apparatus 10 can perform computation analysis within the range of the original image in accordance with the optimal solution of the crop size and the valid size of the base model.

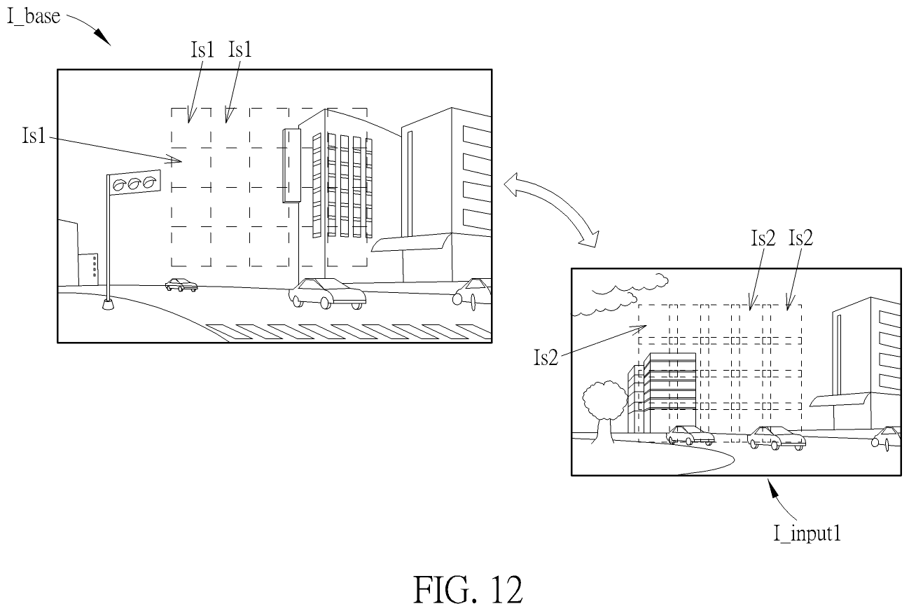

Please refer to FIG. 12 to FIG. 15. FIG. 12 to FIG. 15 are diagrams of the base model and the auxiliary images of the input image according to different embodiments of the present invention. As shown in FIG. 12, a base image I_base of the base model can be a standard size image (such as 2560×1440 pixel resolution), and the input image I_input1 can be a small size image (such as 1920×1080 pixel resolution). The base image I_base can be divided into a plurality of auxiliary images Is1 in accordance with the optimal solution of the crop size and the valid size of the base model. The size of the input image I_input1 can be smaller than the size of the base image I_base, and the image analysis apparatus 10 can divide the input image I_input1 into a plurality of auxiliary images Is2 in a partly overlapped manner, so that the crop size and the valid size of the base image I_base and a number of the auxiliary images Is1 can be the same as the crop size and the valid size of the input image I_input1 and a number of the auxiliary images Is2. The image analysis apparatus 10 can determine a focus status of the input image I_input1 by a focus analysis rule trained by the base model.

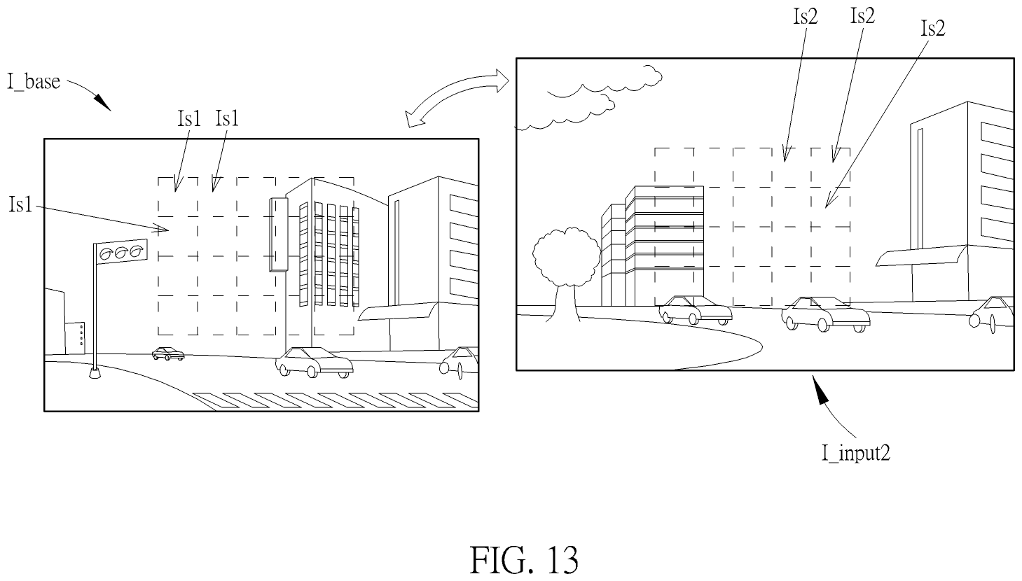

As shown in FIG. 13, the base image I_base of the base model can be the standard size image (such as 2560×1440 pixel resolution), and the input image I_input2 can be a large size image (such as 3840×2160 pixel resolution). The base image I_base can be divided into the plurality of auxiliary images Is1 that is close to each other in accordance with the optimal solution of the crop size and the valid size of the base model. The size of the input image I_input2 can be greater than the size of the base image I_base, so that the image analysis apparatus 10 can divide the specific range of the input image I_input2 into the plurality of auxiliary images Is2, and the crop size and the valid size of the base image I_base and the number of the auxiliary images Is1 can be the same as the crop size and the valid size of the input image I_input2 and the number of the auxiliary images Is2; the image analysis apparatus 10 can determine the focus status of the input image I_input2 by the focus analysis rule trained by the base model. Therefore, the embodiment can set the specific range within a center area of the input image I_input2 for division of the auxiliary images.

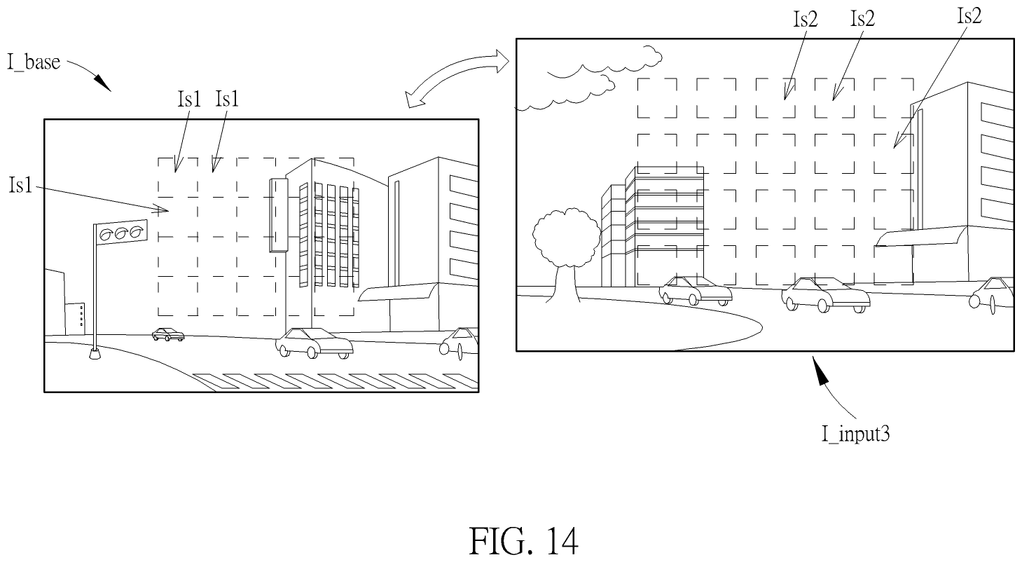

As shown in FIG. 14, the base image I_base of the base model can be the standard size image (such as 2560×1440 pixel resolution), and the input image I_input3 can be the large size image (such as 3840×2160 pixel resolution). The base image I_base can be divided into the plurality of auxiliary images Is1 in accordance with the optimal solution of the crop size and the valid size of the base model. The size of the input image I_input3 can be greater than the size of the base image I_base, so that the image analysis apparatus 10 can set and divide the specific within the input image I_input3 into the plurality of auxiliary images Is2 that is separated from each other, and the crop size and the valid size of the base image I_base and the number of the auxiliary images Is1 can be the same as the crop size and the valid size of the input image I_input3 and the number of the auxiliary images Is2; the image analysis apparatus 10 can determine the focus status of the input image I_input3 by the focus analysis rule trained by the base model. Therefore, the embodiment can set the specific range within the input image I_input3 for division of the auxiliary images Is2 that is uniformly separated from each other.

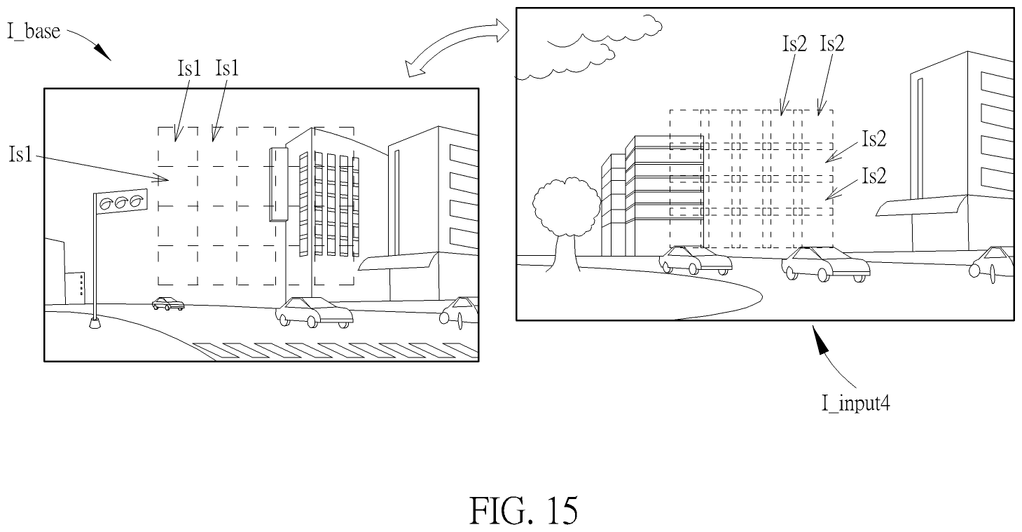

As shown in FIG. 15, the base image I_base of the base model can be the standard size image (such as 2560×1440 pixel resolution), and the input image I_input4 can be the large size image (such as 3840×2160 pixel resolution). The base image I_base can be divided into the plurality of auxiliary images Is1 in accordance with the optimal solution of the crop size and the valid size of the base model. The size of the input image I_input4 can be greater than the size of the base image I_base. The image analysis apparatus 10 may only detect a partial area inside the input image I_input4, and the plurality of auxiliary images Is2 that is uniformly distributed can be automatically divided in accordance with the size of the partial area inside the input image I_input4; in the meantime, an overlapped ratio of the auxiliary images Is2 can be decided in accordance with the size of the partial area, instead of a fixed value. The crop size and the valid size of the base image I_base and the number of the auxiliary images Is1 can be the same as the crop size and the valid size of the input image I_input4 and the number of the auxiliary image Is2. The image analysis apparatus 10 can determine the focus status of the input image I_input4 by the focus analysis rule trained by the base model.

The image analysis apparatus 10 can decide how to match parameters and the input image in accordance with the need for changing the classification criterion; the image analysis apparatus 10 can set the specific range within the center area of the input image I_input1 or the input image I_input2 as the reference image for division of the auxiliary images Is2, or can set the specific range within the input image I_input3 as the reference image by manual setting of automatic computation for division of the auxiliary images Is2, or can automatically divide the input image I_input4 into the auxiliary images Is2 in accordance with the size of the partial area. Therefore, the input image of various sizes can be used to determine the focus status by the trained base model, and can dynamically adjust the interval between the auxiliary images or an overlapped range of the auxiliary images in accordance with a user demand (such as a rigor degree of judging focus misalignment), so as to change the classification criterion for optimization.

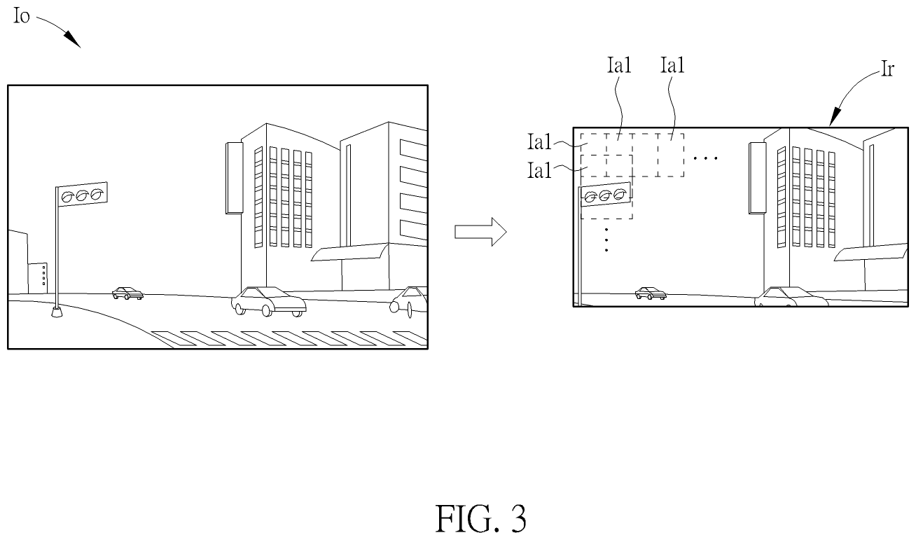

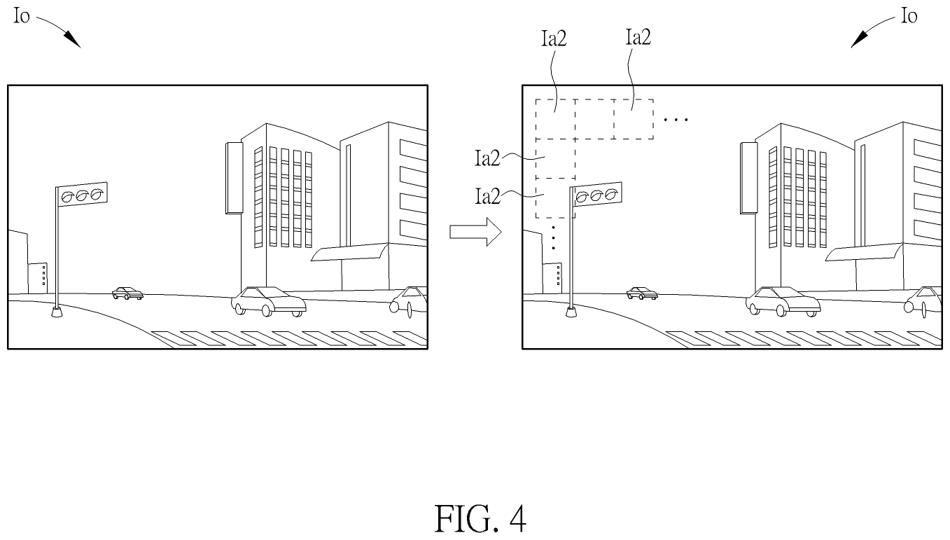

That is to say, the image analysis method and the image analysis apparatus 10 of the present invention can directly set the specific range within the original image (such as the input image I_input2, I_input3, or I_input4) as the reference image (which means a whole range covered by the plurality of auxiliary images Is2 shown in FIG. 13 to FIG. 15). The image classification result may be not changed if the plurality of auxiliary images Is2 that is divided from the reference image set within the original image is applied for the image analysis model. Further, the image analysis method and the image analysis apparatus 10 of the present invention can reduce the original image reduce into the analysis image (such as the input image I_input1 having the size smaller than the size of the base image I_base), and the specific range of the analysis image (which means the input image I_input1) can be set to define as the reference image (which means the whole range covered by the plurality of auxiliary images Is2 shown in FIG. 12). When the original image is reduced into the analysis image to set as the reference image, and the plurality of auxiliary images Is2 that is partly overlapped with each other and divided from the reference image is applied for the image analysis model, the image classification result can be changed and optimized. The auxiliary images Is2 shown in FIG. 12 to FIG. 15 can be interpreted as the first auxiliary images Ia1 shown in FIG. 3, and the auxiliary images Is1 shown in FIG. 12 to FIG. 15 can be interpreted as the second auxiliary image Ia2 shown in FIG. 4.

Please refer to FIG. 3 and FIG. 4. FIG. 3 and FIG. 4 are diagrams of the original image Io acquired by the image analysis apparatus 10 in different operation modes according to the embodiment of the present invention. Due to different actual demands, such as increase of the feature difference to enhance the image classification result, the image analysis method can directly set the specific range within the original image Io as the reference image Ir for division of the auxiliary images; or, the image analysis method can directly reduce the size of the reduce original image Io to set the reduced original image Io as the analysis image, and then set the specific range within the analysis image as the reference image Ir for division of the auxiliary images. The reference image Ir can be divided into the plurality of first auxiliary images Ia1 in accordance with the crop size and/or the valid size in the partly overlapped manner, or in the spaced manner, or in the fitted manner. If the image classification result of the image analysis model in the base model is intended to acquire, the image analysis method can divide the original image Io into the plurality of second auxiliary images Ia2 in accordance with the crop size and/or the valid size in the non-overlapped manner, which means execution of the foresaid base model. The number of the plurality of second auxiliary images Ia2 can be the same as the number of the plurality of first auxiliary images Ia1. For example, there may have five first auxiliary images Ia1 that are partly overlapped with each other and located in a horizontal direction of the reference image Ir, and further have three first auxiliary images Ia1 that are partly overlapped with each other and located in a vertical direction of the reference image Ir, as shown in FIG. 3; meanwhile, there may have five second auxiliary images Ia2 that are not overlapped and located in the horizontal direction of the original image Io, and further have three second auxiliary images Ia2 that are not overlapped and located in the vertical direction of the original image Io, as shown in FIG. 4. Application of the first auxiliary images Ia1 and the second auxiliary images Ia2 in the image analysis model will be explained in the following description.

The image analysis apparatus 10 and the image analysis method of the present invention can divide the original image Io into the plurality of second auxiliary image Ia2 in the non-overlapped manner, and the second auxiliary image Ia2 can be applied to the image analysis model for adaptive adjustment, so as to learn the image classification feature and the image classification rule and to acquire the related image classification result; it should be mentioned that the foresaid image analysis model is not limited to any specific adjustment process, and not the design purpose of the present invention. When the related image classification result is acquired, the image analysis apparatus 10 and the image analysis method of the present invention can further reduce the original image Io into the analysis image for setting the specific range as the reference image Ir, and the reference image Ir can be divided into the plurality of first auxiliary images Ia1 in the partly overlapped manner, and then the plurality of first auxiliary images Ia1 can be applied for the image analysis model to increase the feature difference and enhance the image classification result.

Relation between a reduction ratio of the original image Io to the reference image Ir, and the partly overlapped percentage of scene in the plurality of first auxiliary images Ia1 can be explained in the following description. As shown in FIG. 3, if the original image Io is reduced by a first preset ratio of 75% to generate the reference image Ir, the adjacent first auxiliary images Ia1 can be partly overlapped by a second preset ratio of 25%; which means a sum of the first preset ratio and the second preset ratio can be equal to 1.0. The numbers of the first auxiliary images Ia1 respectively in the horizontal direction and in the vertical direction of the reference image Ir can be the same as the numbers of the second auxiliary images Ia2 respectively in the horizontal direction and in the vertical direction of the original image Io. Practical application of numbers of the first auxiliary images Ia1 and the second auxiliary images Ia2 is not limited to the foresaid embodiment, and any design having the sum of the first preset ratio and the second preset ratio greater than or equal to 1.0 can belong to a design scope of the present invention. In addition, individual values of the first preset ratio and the second preset ratio are not limited to the foresaid embodiment, which depend on a design demand, and the detailed description is omitted herein for simplicity.

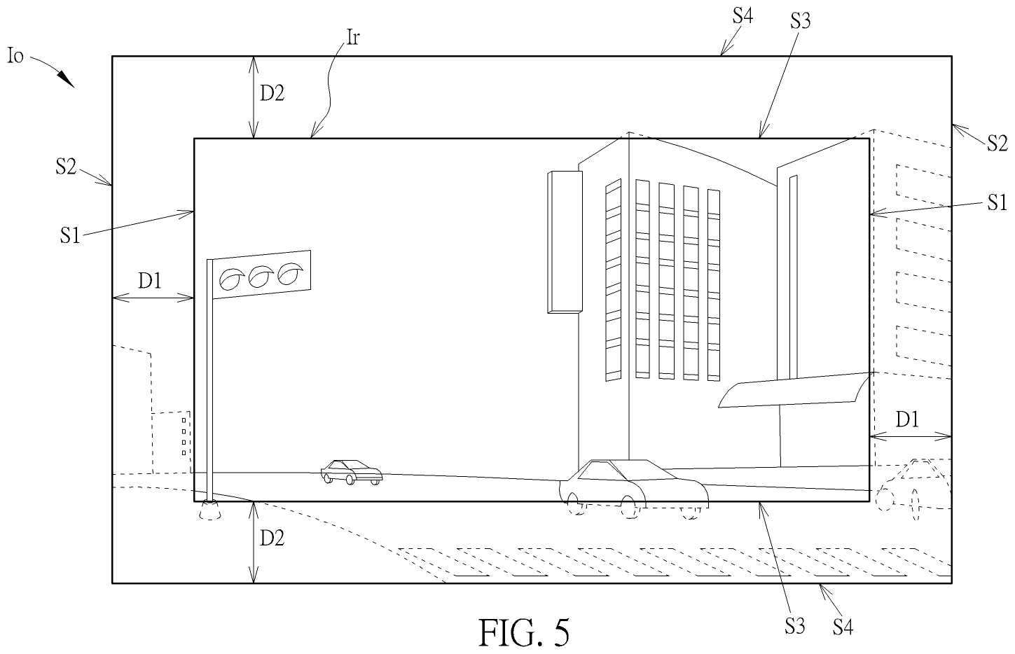

Please refer to FIG. 5 to FIG. 7. FIG. 5 to FIG. 7 are diagrams of utilizing the original image Io to generate the analysis image and reduction of the reference image Ir according to different embodiments of the present invention. In some specific conditions, an object of interest targeted by the image analysis apparatus 10 may be located on center of the original image Io, so that the image analysis method can define relative position between the original image Io and the analysis image in a centered manner, and the specific range of the analysis image can be further set as the reference image Ir; as shown in FIG. 5, if a reduction ratio of the original image Io to the analysis image (or can be indicated as the reference image Ir) is a known value, the image analysis apparatus 10 and the image analysis method of the present invention can align the original image Io to the reference image Ir in a boundary-parallel manner, which means the specific range inside the original image Io can be set as the reference image Ir, and a preset percentage of pixel number difference between the original image Io and the reference image Ir in the horizontal direction can be used to define an interval D1 between a vertical boundary S1 of the reference image Ir and a related vertical boundary S2 of the original image Io, and another preset percentage of the pixel number difference between the original image Io and the reference image Ir in the vertical direction can be used to define an interval D2 between a horizontal boundary S3 of the reference image Ir and a related horizontal boundary S4 of the original image Io; the reference image Ir can be placed in the center of the original image Io. The preset percentage can be preferably set as 50%, and practical application of the preset percentage is not limited to the foresaid embodiment and may have allowable error; for example, the preset percentage within a range of 40% to 60% can be suitable for the present invention.

Moreover, the present invention can further find out the center (which are not shown in the figures) of the original image Io and the reference image Ir when a size difference ratio between the original image Io and the reference image Ir is a known value, and align the center of the reference image Ir with the center of the original image Io and make the horizontal boundary and the vertical boundary of the reference image Ir be respectively parallel to the horizontal boundary and the vertical boundary of the original image Io, for placing the reference image Ir on the center of the original image Io. The present invention can still define the relative position between the original image Io and the reference image Ir via other centered manners, and is not limited to the foresaid embodiment.

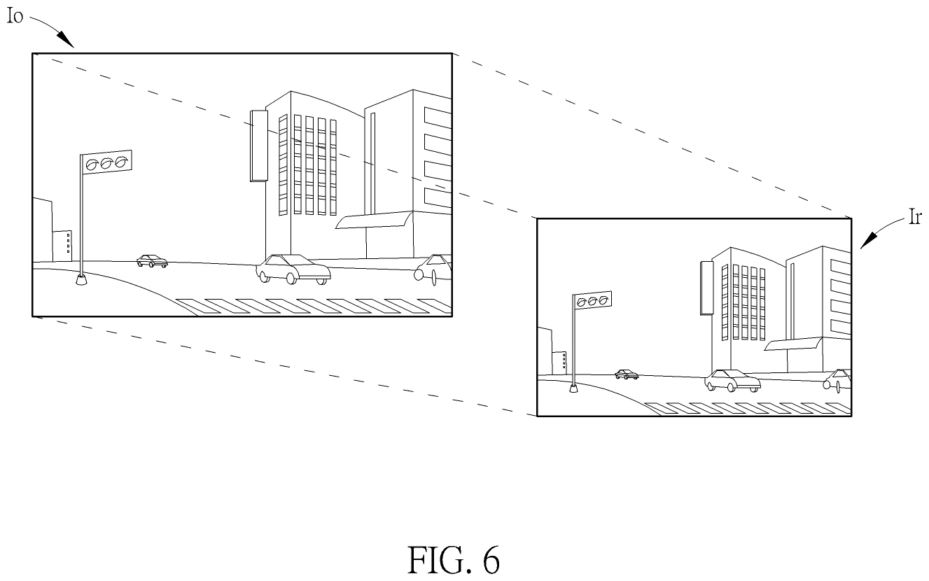

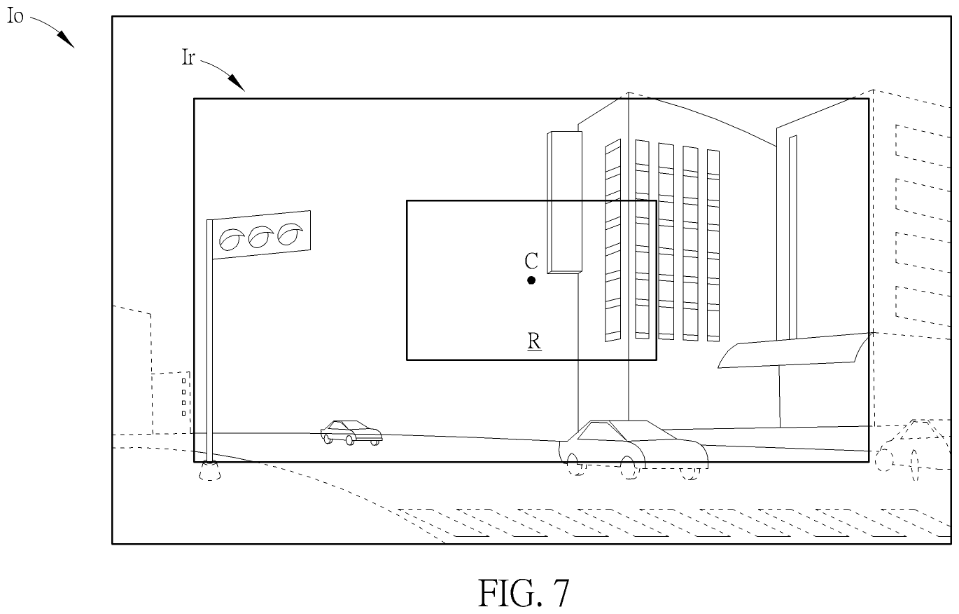

As shown in FIG. 6, the image analysis apparatus 10 and the image analysis method of the present invention can select the preset ratio and use the preset ratio to directly adjust the vertical size and the horizontal size of the original image Io for generating the analysis image. The specific range within the analysis image can be set as the reference image Ir, which means the whole size of the original image Io can be directly reduced; an actual value of the preset ratio can depend on the design demand. Further, as shown in FIG. 7, if a preset reduction ratio between the original image Io and the analysis image (or can be indicated as the reference image Ir) is known, the image analysis apparatus 10 and the image analysis method of the present invention can further utilize a foreground detection technology to draw a region of interest R within the original image Io, and a size of the region of interest R can be greater than, equal to, or smaller than the size of the reference image Ir; a coverage range of the reference image Ir within the original image Io can be set by finding a center C of the region of interest R and aligning the center of the reference image Ir with the center C.

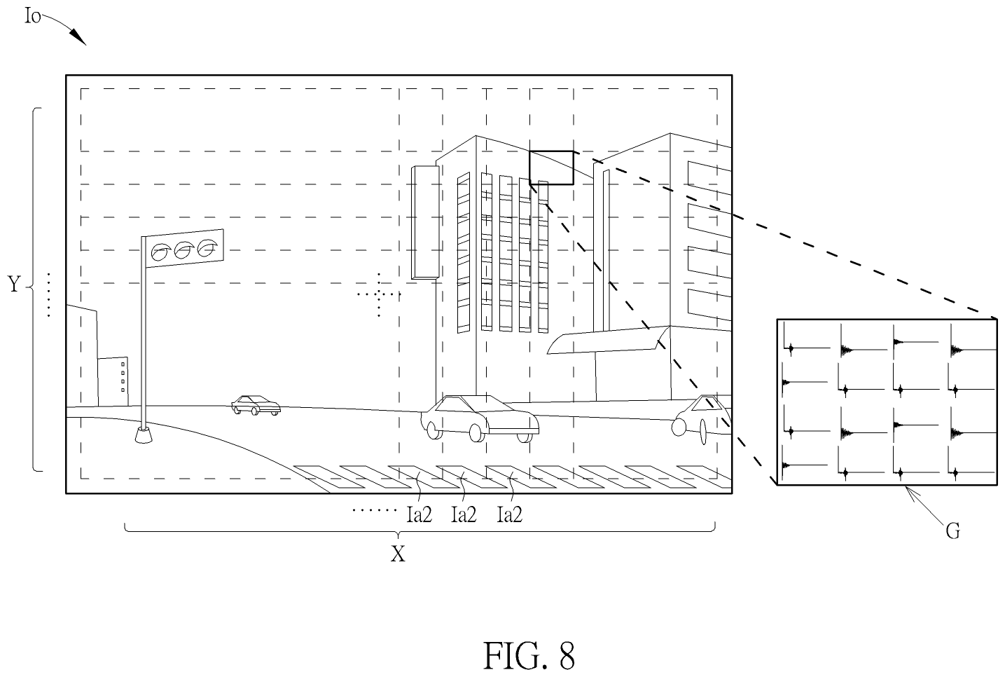

Please refer to FIG. 8 to FIG. 11. FIG. 8 to FIG. 11 are diagrams of the original image Io in different transformation phases at the frequency domain according to the embodiment of the present invention. The image analysis method illustrated in FIG. 2A and FIG. 2B can be suitable for the image analysis apparatus 10 shown in FIG. 1 and the original image Io shown in FIG. 8 to FIG. 11. First, step S100 can be executed that the image analysis method can divide the original image Io into the plurality of second auxiliary images Ia2 via the valid size. The image analysis method may divide the whole original image Io into the plurality of second auxiliary images Ia2 via the valid size, or can divide the specific range inside the original image Io into the plurality of second auxiliary images Ia2 via the valid size; the specific range can be the predefined region of interest, or can be a part of the original image Io marked by motion detection, and practical application of the specific range can depend on the design demand. The preferred embodiment can uniformly divide the whole original image Io into the plurality of second auxiliary images Ia2, and only some of the second auxiliary images Ia2 are marked in FIG. 8 for simplicity.

Then, step S102 and step S104 can be executed to transform the plurality of second auxiliary images Ia2 from the spatial domain to the frequency domain for generating a plurality of frequency domain images, and distribute the plurality of frequency domain images into several crop groups G via a predefined set value S. The predefined set value S can be indicated as the number of rows or columns of a more subdivided frequency domain image cut from the valid size within the range specified by the crop size. If the image analysis method divides the specific range of the original image Io into the second auxiliary images Ia2, the division-acquired second auxiliary images Ia2 or the related frequency domain images can be set as one crop group G. In the preferred embodiment of the present invention, the whole original image Io can be divided into the plurality of second auxiliary images Ia2, and each of the plurality of second auxiliary images Ia2 can be transformed into one frequency domain image; a specific number of the second auxiliary image Ia2 or the related frequency domain images can be defined as one crop group G, as shown in FIG. 8. For example, the image size of the original image Io may have 2560×1280 pixels; if the valid size is 64 pixels, the original image Io can be divided into the plurality of second auxiliary images Ia2 arranged in an array 40×20, and the image size of each second auxiliary image Ia2 can have 64×64 pixels; if the predefined set value S is 4, each crop group G can have the second auxiliary images Ia2 or the frequency domain images arranged in an array 4×4. In different embodiments, the predefined set value S of the number of rows or columns can be the same or different from each other, which depends on the design demand.

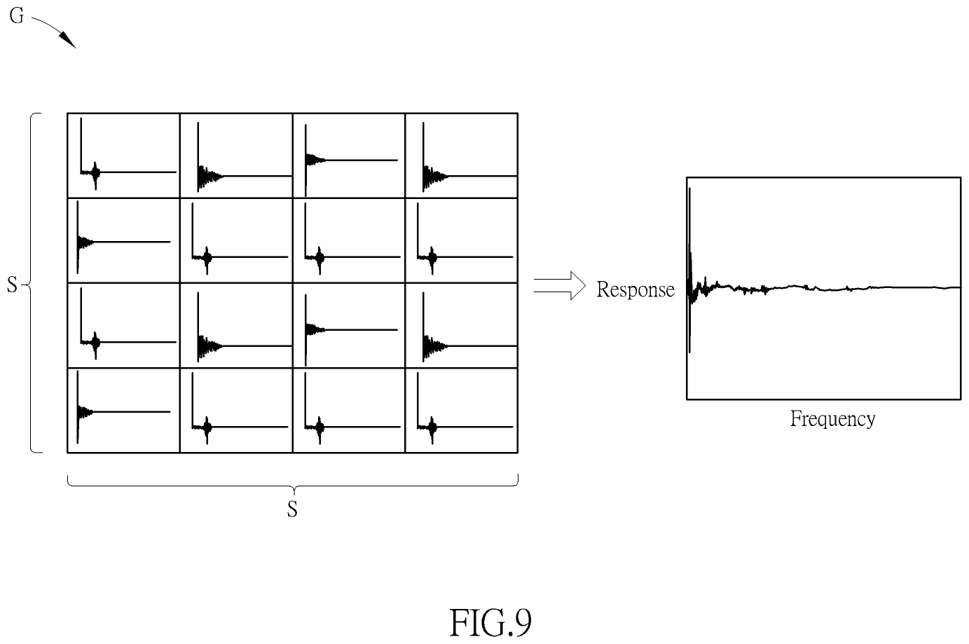

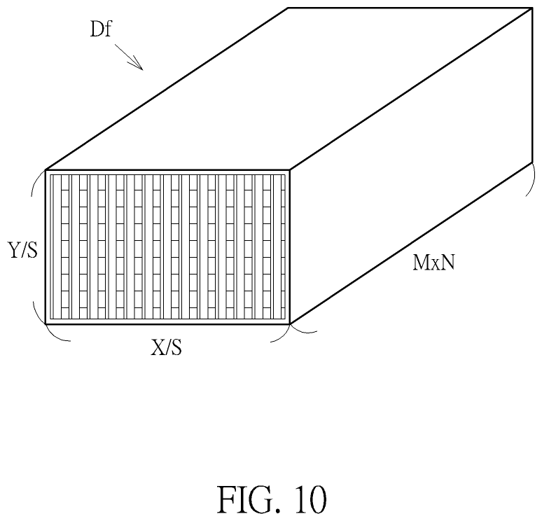

Then, step S106 and step S108 can be executed to analyze several frequency responses at the same frequency in several frequency domain images contained by each crop group G to generate a representative frequency response, and collect several representative frequency responses of the crop groups G at all frequencies to define as frequency domain group data Df corresponding to the crop groups G. The unit of the horizontal axis of the frequency domain image is frequency, and the unit of the vertical axis of the frequency domain image is response. The horizontal axis of the frequency domain image can correspond to a depth value “M×N” (ex. 4096=64×64) of the frequency domain group data Df. Therefore, step S106 can acquire 16 frequency responses respectively from 16 frequency domain images at any frequency in each crop group G, and utilize the 16 frequency responses to generate the representative frequency response for the foresaid frequency; the embodiment can find out the largest frequency response from the 16 frequency responses to set as the representative frequency response, and practical application of the representative frequency response is not limited to the above-mentioned embodiment. Each frequency in the crop group G can have one representative frequency response, and step S108 can collect the representative frequency responses of all frequencies (which may be equal to the depth value as 4096) in each crop group G to individually generate the frequency domain group data Df, as shown in FIG. 9 and FIG. 10.

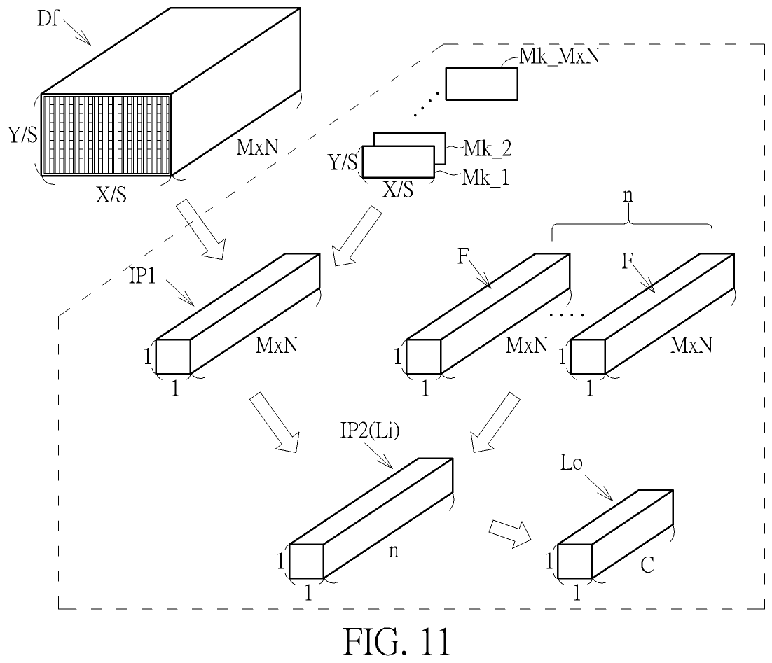

Then, step S110, step S112, step S114 and step S116 can be executed to compute an inner product of the frequency domain group data Df and a plurality of masks Mk for generating a first inner product IP1, to compute an inner product of the first inner product IP1 and a plurality of filters F for generating a second inner product IP2 to set as an input layer Li of a fully connected multilayer perceptron, to transform the input layer Li into an analysis model output layer Lo via the fully connected multilayer perceptron, and to acquire a prediction result of the original image Io in accordance with a category determination result of the analysis model output layer Lo. As shown in FIG. 11, a number of the masks Mk can be M×N. The M×N masks Mk can be used to respectively compute its inner product with the frequency domain group data Df having the depth value 1˜M×N to acquire the first inner product IP1 with a size of 1×1×“M×N”. The first inner product IP1 can be used to respectively compute its inner product with the n filters F to acquire the second inner product IP2 with a size of 1×1×n. The analysis model output layer Lo can optionally include several prediction categories C, such as a focus category, a slightly out of focus category, an obviously out of focus category, and a completely out of focus category. Information of the mask Mk, the filter F and the prediction category C can depend on the design demand of the image analysis method or the image analysis apparatus 10, and the detailed description is omitted herein for simplicity.

Then, step S117 and step S118 can be executed to decide whether to adjust parameters of the mask Mk, the filter F and/or the fully connected multilayer perceptron (which may be acquired in step S110, step S112 and step S114) by the training image, and further determine whether to adjust the valid size in accordance with the prediction result of the original image Io when the related parameters are adjusted or no need to adjust; this step can be judged by trial and error, or any applicable solving rules. If the prediction result is not as accurate as expected, step S120 can be executed to reduce the valid size, and the image analysis method can execute step S100 for relevant process again; if the valid size is accurate as expected, the valid size is not adjusted, and step S122 can be executed to divide the original image Io directly by the current valid size; the prediction result of the frequency domain group data Df generated by foresaid division can be compared with a target label, so as to adjust a phase parameter of the frequency domain group data Df in each transformation phase in accordance with a comparison result, for optimizing the prediction result of next phase

Therefore, the image analysis method shown in FIG. 2A can divide the original image Io into the plurality of second auxiliary images Ia2, and set an array parameter of the second auxiliary images Ia2 or the related frequency domain images contained by each crop group G in accordance with the predefined set value S; then, the largest frequency response of all the frequency domain images at the same frequency in each crop group G can be found out to generate an integrated frequency domain image corresponding to each crop group G. The frequency response of the integrated frequency domain image at each frequency on the horizontal axis can be set as the largest one of the 16 frequency responses of the integrated frequency domain images at the related frequency contained by each crop group G corresponding to the integrated frequency domain image. The integrated frequency domain images of all the crop groups G can be transformed into the frequency domain group data Df, and the frequency domain group data Df can be applied to the image analysis model for determining whether to adjust the valid size of the second auxiliary image Ia2, so as to rapidly and accurately find classification rules that best match with the input image of the image analysis model and the target label of an expected model, for achieving a purpose of image analysis and identification.

In the image analysis method shown in FIG. 2B, elements having the same numerals as ones of the image analysis method shown in FIG. 2A have the same definition and functions, and the detailed description is omitted herein for simplicity. First, step S200 and step S202 can be executed to divide the original image Io into a plurality of auxiliary images via the crop size, and transform the plurality of auxiliary images from the spatial domain to the frequency domain for generating the plurality of frequency domain images and a plurality of pre-processing frequency domain data. The crop size can be greater than or equal to the valid size, and can be an integer multiple of the valid size. If the crop size is equal to the valid size, it can represent that features in a range contained by the crop size are accurate; if the crop size is greater than the valid size, it can represent that the features in the range contained by the crop size is inaccurate, and the valid size can be used to further define the features accurately. Then, step S204, step S206, step S208 and step S210 can be executed to compute the inner product of the pre-processing frequency domain data and the masks for generating the first inner product, to compute an inner product of the first inner product and the filters for generating the second inner product to set as the input layer of the fully connected multilayer perceptron, to transform the input layer into the analysis model output layer via the fully connected multilayer perceptron, and to acquire the prediction result of the original image Io in accordance with the category determination result of the analysis model output layer.

Functions of step S204, step S206, step S208 and step S210 can be similar to functions of step S110, step S112, step S114 and step S116, and the detailed description is omitted herein for simplicity. Then, step S212 and step S214 can be executed to decide whether to adjust the parameters of the mask Mk, the filter F and/or the fully connected multilayer perceptron (which may be acquired in step S204, step S206 and step S208) by the training image, and determine whether to adjust the crop size in accordance with the prediction result of the original image Io when the related parameters are adjusted or no need to adjust. The image analysis method shown in FIG. 2B can acquire the prediction result via step S210, and then decide whether to adjust the crop size in accordance with accuracy of the prediction result, for acquiring the optimal solution of the crop size. When the optimal solution of the crop size is acquired, the image analysis method shown in FIG. 2A can be executed to find the optimal solution of the valid size, and analyze the crop size and the valid size to compute the predefined set value S. For example, if the prediction result meets expectation in step S214, the crop size acquired in step S214 can be used to compute the required valid size, and the crop size is not adjusted in step S216 then process of step S100 to step S122 can be executed accordingly. If the prediction result does not meet the expectation in step S214, step S218 can be executed to adjust the crop size and then return to step S200 for further execution of related process. When the optimal solution of the crop size and the valid size, and the predefined set value S related to the foresaid optimal solution are acquired, which means the prediction result meets the expectation in step S214, the following original image Io can be directly divided into the auxiliary images via the valid size, and the image analysis method shown in FIG. 2A can be executed to rapidly and accurately find the classification rules that best match with the input image of the image analysis model and the target label of the expected model, for achieving the purpose of the image analysis and identification.

The preferred embodiment of the present invention can execute the image analysis method shown in FIG. 2B to utilize step S200 and step S202 to position the feature range inside the original image Io, and further utilize steps S204˜S212 to adjust parameters of each layer in the image analysis model, and further utilize step S214 to decide whether or how to adjust the crop size. When the crop size is decided, the image analysis method shown in FIG. 2A can be executed to utilize steps S100˜S108 to precisely define the features inside the original image Io, and utilize steps S110˜S117 to adjust the parameters of each layer in the image analysis model, and then utilize steps S118˜S122 to decide whether or how to adjust the valid size, for acquiring the image classification result of the image analysis model.

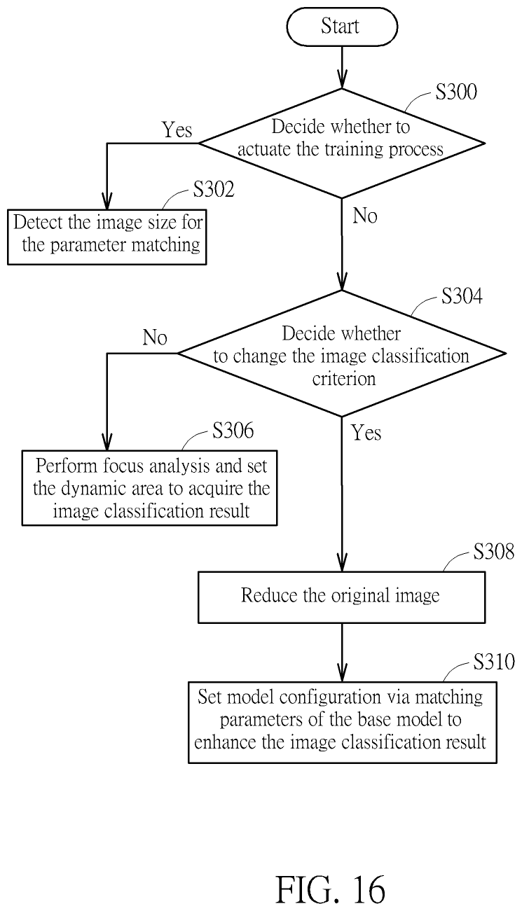

Please refer to FIG. 16. FIG. 16 is a flow chart of the image analysis method according to the embodiment of the present invention. First, step S300 can be executed to decide whether to actuate the training process. If the training process is actuated, step S302 can be executed to detect the image size for the parameter matching, which means the image analysis method shown in FIG. 2A and FIG. 2B can be executed to acquire the optimal solution of the crop size and the valid size. If the training process is not actuated, step S304 can be executed to decide whether to change the image classification criterion. If the image classification criterion is not changed, step S306 can be executed to perform focus analysis and set the dynamic area, for completing analysis and acquiring the image classification result; the image classification result in the situation can be similar to the classification criterion of the base model. If the image classification criterion is changed, step 308 and step 310 can be executed to reduce the original image Io and set model configuration via matching parameters in step S302. Overlapping of the auxiliary images may cause the response of the area where on the features are located to be superimposed, so the computed image classification expectation can be dynamically adjusted; the computed image classification expectation can be, but not limited to, classification results of the prediction categories C, such as the focus category, the slightly out of focus category, the obviously out of focus category, and the completely out of focus category.

In conclusion, the image analysis apparatus and the image analysis method of the present invention can divide the original image into the plurality of auxiliary images in accordance with the crop size and/or the valid size via down-sampling technology, and apply the plurality of auxiliary images for the image analysis model to acquire the image classification result, so as to rapidly and accurately acquire the classification rules that best match with the input image matched of the image analysis model and the target label of the expected model; then, the original image can be reduced to generate the reference image, and the reference image can be divided into the plurality of auxiliary images in accordance with the crop size and/or the valid size to apply for the image analysis model, so as to decide the feature range and precise features inside the input image. Comparing to prior art that an analysis model re-trains the base model for adjustment of the classification result, the image analysis apparatus and the image analysis method of the present invention does not re-execute the training process of the base model, and can apply the matching parameters of the original base model directly for the reduced original image, so as to dynamically adjust the strict classification criterion to the loose and expected classification criterion, and further to increase the feature difference and enhance the image classification result, for achieving the expected effect of effectively adjusting the classification.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image analysis method applied to an image analysis apparatus, the image analysis apparatus having an operation processor and an image receiver, the image receiver being adapted to acquire an original image relevant to a surveillance environment, the image analysis method comprising:
the operation processor setting a range provided by the original image as a reference image; and
the operation processor dividing the reference image into a plurality of first auxiliary images in accordance with a valid size, so as to apply the plurality of first auxiliary images for an image analysis model to generate an image classification result;
wherein the operation processor is further adapted to divide a base image acquired by the image receiver into a plurality of second auxiliary images in accordance with the valid size, and apply the plurality of second auxiliary images for the image analysis model to decide a number of the plurality of first auxiliary images.

2. The image analysis method of claim 1, wherein the operation processor is adapted to directly define the range within the original image to set as the reference image.

3. The image analysis method of claim 1, wherein the operation processor is adapted to reduce the original image into an analysis image, and define the range within the analysis image to set as the reference image.

4. The image analysis method of claim 3, wherein the operation processor is adapted to divide the reference image defined by the range within the analysis image into the plurality of first auxiliary images, and the image classification result is changed when the plurality of first auxiliary images is applied for the image analysis model.

5. The image analysis method of claim 1, wherein the operation processor is adapted to utilize the valid size to divide the reference image into the plurality of first auxiliary images partly overlapped with each other, or utilize the valid size to divide the reference image into the plurality of first auxiliary images spaced from each other.

6. The image analysis method of claim 5, wherein the operation processor is adapted to divide the reference image into the plurality of first auxiliary images spaced from each other, and the image classification result is not changed when the plurality of first auxiliary images is applied for the image analysis model.

7. The image analysis method of claim 1, wherein the operation processor is adapted to apply the plurality of second auxiliary images for the image analysis model to decide a number of the plurality of second auxiliary images, and decide optimal solution of the valid size, and then divide the reference image via the decided valid size to decide the plurality of first auxiliary images, so that the number of the plurality of first auxiliary images is the same as the number of the plurality of second auxiliary images.

8. The image analysis method of claim 1, wherein the original image divided into the plurality of second auxiliary images is applied for the image analysis model to acquire the image classification result, and the reference image divided into the plurality of first auxiliary images is applied for the image analysis model to change the image classification result.

9. The image analysis method of claim 3, wherein the operation processor is adapted to reduce the original image via a first preset ratio for generating the analysis image, and partly overlap two adjacent first auxiliary images of the plurality of first auxiliary images via a second preset ratio, a sum of the first preset ratio and the second preset ratio is greater than or equal to 1.

10. The image analysis method of claim 9, wherein the operation processor reducing the original image to generate the analysis image comprises:
the operation processor utilizing a preset ratio to change a vertical size and a horizontal size of the original image to generate the analysis image.

11. The image analysis method of claim 9, wherein the operation processor reducing the original image to generate the analysis image comprises:
the operation processor computing a preset percentage of a pixel number difference between the original image and the analysis image in a horizontal direction, so as to define an interval between a vertical boundary of the analysis image and a related vertical boundary of the original image; and
the operation processor computing the preset percentage of a pixel number difference between the original image and the analysis image in a vertical direction, so as to define an interval between a horizontal boundary of the analysis image and a related horizontal boundary of the original image.

12. The image analysis method of claim 9, wherein the operation processor reducing the original image to generate the analysis image comprises:
the operation processor utilize a foreground detection technology to set a region of interest within the original image; and
the operation processor setting a coverage range of the analysis image within the original image based on a center of the region of interest.

13. An image analysis apparatus, comprising:
an image receiver adapted to acquire an original image; and
an operation processor electrically connected with the image receiver, and adapted to set a range provided by the original image as a reference image, and divide the reference image into a plurality of first auxiliary images in accordance with a valid size, so as to apply the plurality of first auxiliary images for an image analysis model to generate an image classification result;
wherein the operation processor is further adapted to divide a base image acquired by the image receiver into a plurality of second auxiliary images in accordance with the valid size, and apply the plurality of second auxiliary images for the image analysis model to decide a number of the plurality of first auxiliary images.

14. The image analysis apparatus of claim 13, wherein the operation processor is adapted to directly define the range within the original image to set as the reference image.

15. The image analysis apparatus of claim 13, wherein the operation processor is adapted to reduce the original image into an analysis image, and define the range within the analysis image to set as the reference image.

16. The image analysis apparatus of claim 15, wherein the operation processor is adapted to divide the reference image defined by the range within the analysis image into the plurality of first auxiliary images, and the image classification result is changed when the plurality of first auxiliary images is applied for the image analysis model.

17. The image analysis apparatus of claim 13, wherein the operation processor is adapted to utilize the valid size to divide the reference image into the plurality of first auxiliary images partly overlapped with each other, or utilize the valid size to divide the reference image into the plurality of first auxiliary images spaced from each other.

18. The image analysis apparatus of claim 13, wherein the operation processor is adapted to apply the plurality of second auxiliary images for the image analysis model to decide a number of the plurality of second auxiliary images, and decide optimal solution of the valid size, and then divide the reference image via the decided valid size to decide the plurality of first auxiliary images, so that the number of the plurality of first auxiliary images is the same as the number of the plurality of second auxiliary images.

19. The image analysis apparatus of claim 13, wherein the original image divided into the plurality of second auxiliary images is applied for the image analysis model to acquire the image classification result, and the reference image divided into the plurality of first auxiliary images is applied for the image analysis model to change the image classification result.

20. The image analysis apparatus of claim 15, wherein the operation processor is adapted to reduce the original image via a first preset ratio for generating the analysis image, and partly overlap two adjacent first auxiliary images of the plurality of first auxiliary images via a second preset ratio, a sum of the first preset ratio and the second preset ratio is greater than or equal to 1.
